(19) United States
(12) Patent Application Publication
(10) Pub. No.: US 2013/0314928 A1
(43) Pub. Date: Nov. 28, 2013

(54) SEMICONDUCTOR LIGHTING DEVICE AND METHOD FOR INSTALLING A COVER ON A MOUNTING OF A SEMICONDUCTOR LIGHTING DEVICE

(71) Applicants: Thomas Bittmann, Friedberg (DE); Nicole Breidenassel, Bad Abbach (DE); Klaus Eckert, Herbrechtingen (DE); Markus Hofmann, Bad Abbach (DE)

(72) Inventors: Thomas Bittmann, Friedberg (DE); Nicole Breidenassel, Bad Abbach (DE); Klaus Eckert, Herbrechtingen (DE); Markus Hofmann, Bad Abbach (DE)

(73) Assignee: OSRAM GMBH, Muenchen (DE)

(21) Appl. No.: 13/984,059

(22) PCT Filed: Jan. 26, 2012
(86) PCT No.: PCT/EP2012/051221

§ 371 Date: Aug. 7, 2013

(30) Foreign Application Priority Data
Feb. 11, 2011 (DE) 10 2011 003 968.6

(51) Int. Cl. F21V 3/00; F21V 17/10

(52) U.S. Cl. CPC F21V 3/00; F21V 17/10
USPC 362/363; 29/592.1

(57) ABSTRACT

A semiconductor lighting device includes a translucent cover and a mounting for the cover, wherein the mounting has an annular groove, the cover is inserted into the annular groove and the cover is held in the annular groove, at least on a first side, by means of an adhesive.

### RELATED APPLICATIONS

The present application is a national stage entry according to 35 U.S.C. §371 of PCT application No.: PCT/EP2012/051221 filed on Jan. 26, 2012, which claims priority from German application No.: 10 2011 003 968.6 filed on Feb. 11, 2011.

### TECHNICAL FIELD

Various embodiments relate to semiconductor lighting devices which each includes a translucent cover and a mounting for the cover. Various embodiments further relate to methods for installing a cover of a semiconductor lighting device on a mounting of the semiconductor lighting device.

### BACKGROUND

LED lamps are known in which a translucent cover (“bulb”) made of glass is fixed to a heat sink made of aluminum. The thermal expansion coefficients of glass and aluminum differ considerably, so that, without suitable measures, it is possible for stresses, cracking and even fracture of the glass bulb to occur.

In order to avoid damage to the glass bulb, LED lamps are known in which the translucent cover is adhesively bonded onto a flexible and thin plastic ring and the plastic ring is adhesively bonded onto a heat sink. The different thermal expansions of the heat sink and of the bulb in the radial direction are partly compensated for by deformation of the plastic ring.

### SUMMARY

Various embodiments provide an improved attachment of a translucent cover to a semiconductor lighting device.

Various embodiments provide a semiconductor lighting device including a translucent cover and a mounting for the cover, wherein the mounting has an annular groove, the cover is inserted into the annular groove and the cover is held in the annular groove, at least on a first side, by means of an adhesive.

This semiconductor lighting device makes it possible that different thermal expansions of the cover and the mounting do not need to be compensated for by deformation of the mounting or another pre-formed solid body. Instead, the different thermal expansion can be compensated for by play of the cover in the groove (in particular on the non adhesively-bonded side) and/or by deformation of the adhesive. Thus, in particular, large relative displacements can be realized and/or a build-up of stress in the cover can be reduced.

One development is that the cover is substantially connected to the mounting via the adhesive. Thus, a thermal connection to the mounting is likewise made substantially via the adhesive.

A development that is advantageous for thermal conduction of heat through the adhesive is that the cover and the annular groove have a substantially conformal contour in their contact region or contact area introduced by the adhesive. Thus, the adhesive can be present over a large area as a thin layer, which keeps thermal resistance low.

The first side can correspond to an outer side of the cover or an edge region thereof. The outside of the cover may in particular then be fixed to an outer circumferential edge of the annular groove by means of the adhesive.

In particular for this case, it is advantageous for making a simple and firm contact that the cover has an undercut, in particular tapering, edge region. To this end, the cover may have, for example, the shape of a spherical cap or spherical dome which extends beyond the equator or mid-plane thereof.

Alternatively, the first side may correspond to an inner side of the cover or of an end region thereof. The inner side of the cover may then in particular be fixed to an inner circumferential edge of the annular groove by means of the adhesive.

In particular for this case, it is advantageous for making a simple and firm contact that the cover has a widening edge region. To this end, the cover can, for example, have the shape of a spherical cap or spherical dome which does not cover the equator.

The cover may be transparent or opaque.

The cover may consist of plastic or glass, for example opal glass.

One refinement is that the cover is held in the annular groove, at least on a second side thereof, in a form-fitting manner by means of an adhesive. As a result, it is possible to prevent the cover detaching from the mounting in the event of degradation of the adhesive action of the adhesive.

A further refinement is that the second side is an inner side, the cover is inserted into the annular groove with an undercut, in particular tapering, edge region, and the annular groove has an undercut on the inner side thereof. The cover can be inserted simply into the annular groove, while the adhesive (following curing thereof) permits the form-fitting retention (on the inner side) of the cover in the annular groove even in the event of a reduced adhesive action.

An alternative refinement is that the second side is an outer side, the cover is inserted into the annular groove with a widening edge region, and the annular groove has an undercut on the outer side thereof. The cover may also be inserted simply into the annular groove here, while the adhesive (following curing thereof) permits the form-fitting retention (on the outer side) of the cover in the annular groove even in the event of a reduced adhesive action.

A refinement for obtaining minimal adhesive thicknesses is that the adhesive has spacers made of filler, for example small spheres, in particular glass spheres. This ensures an adequate adhesive action.

A refinement that is advantageous for a particularly effective reduction of thermal stresses, in particular in the cover, is that the adhesive may be deformed elastically. In order to avoid damage to the adhesive and/or the adhesive connection in the event of a varying thermal loading, the adhesive exhibits high elongation at failure. The adhesive is particularly preferably a silicone adhesive.

Advantageously, the adhesive has a high thermal conductivity. In particular, a silicone adhesive having an electrically conductive filler, e.g. graphite, metal particles, carbon nanotubes and so on, may be used for this purpose.

Various embodiments provide a semiconductor lighting device including a translucent cover and a mounting for the cover, wherein the cover has a widened (or thicker) edge region and is adhesively bonded with the widened edge region (in particular an associated front side) onto a substantially horizontal attachment surface the mounting. By means of the widened wall region (which has a thicker wall thickness than the rest of the cover), an enlarged contact surface with a correspondingly higher thermal transfer capability and a larger adhesive surface is provided, while the rest of the cover has a comparatively low wall thickness and therefore, overall, also a low weight. The attachment via the substantially horizontal attachment surface has the further advantage of a low overall height or thickness of the adhesive connection. Furthermore, the application of the adhesive is also relatively simply possible, e.g. by being dispensed onto the attachment surface. The attachment surface is preferably substantially flat. A further advantage is the low thermo-mechanical stress which results in the case of this form of attachment. In particular, if there is no form-fitting connection, in the case of a different thermal expansion of the materials, no substantial stresses occur in the cover either.

One development is that the edge region of the cover (in particular the front face) making contact with the attachment surface has a width or wall thickness of in particular about 3 mm to 5 mm, which permits good thermal contact, high adhesive force and a still low weight.

One refinement is that the attachment surface has at least one recess (e.g. channel or trough) covered by the cover. The at least one recess can advantageously be used to receive excess adhesive.

The cover having the widened edge region may also be used as the cover of the semiconductor lighting device in which the mounting has an annular groove, the cover is inserted into the annular groove and the cover is held in the annular groove, at least on a first side, by means of an adhesive.

Various embodiments further provide a semiconductor lighting device including a translucent cover that is undercut in an edge region, in particular tapers, and a mounting for the cover, wherein the cover is pressed onto the mounting by means of a clamping ring attaching to an inner side of the edge region of said cover.

One refinement is that the clamping ring is configured to be wedge-shaped, at least in some sections, and is arranged with the at least one wedge-shaped region thereof between the inner side of the cover and the mounting. Thus, the clamping ring is able to achieve a particularly firm force-fitting and form-fitting connection of the cover to the mounting. The at least one wedge-shaped region may, for example, include one or more wedge-shaped incisions or segments, in particular circular segments. Alternatively, the clamping ring may also be configured to be wedge-shaped over substantially the entire circumference thereof. In this case, the clamping ring may in particular be configured to be closed or else open in order to change the circumference.

One development is that the clamping ring is fixed by means of at least one screw, in particular a self-tapping screw. By means of the at least one screw, the clamping ring in particular may be drawn against the cover. By means of controlled tightening of the screws, the compressive force on the bulb may be adjusted.

One development is that the clamping ring is inserted into an annular groove in the mounting, into which the cover is also inserted. By means of the clamping ring, the cover may then in particular be pressed against an outer side wall of the annular groove. On the other side, the clamping ring may be supported on an inner region of the mounting surrounded by the annular groove, in particular on an inner side wall of the annular groove.

A further refinement is that the clamping ring is arranged between the inner side of the cover and the mounting and can be deformed elastically in the radial direction, at least in some sections. The sections or segments that can be deformed in the radial direction are able to press the cover against the mounting from the inside and thus hold the latter in the mounting in a form-fitting and possibly force-fitting manner against the inherent weight thereof, even in a position oriented upside down. The segments that may be deformed in the radial direction may in particular have spring elements.

A development that is advantageous for secure fixing is that the elastic segments project radially beyond the free edge of the cover and thus achieve the form fit.

Said clamping ring may in particular be inserted into the inner side of the cover, so that the clamping ring assumes a predetermined position there. The clamping ring may, for example, be latched or clamped into the cover, in particular clipped in.

Said clamping ring may in particular be latched into the mounting. To this end, the clamping ring can have at least one latching element, e.g. latching hooks or latching lugs. The mounting may have matching opposing latching elements, for example latching cutouts in the base of the annular groove or an undercut inner side wall.

There is also a refinement is which the clamping ring may be deformed elastically in the circumferential direction thereof, at least in some sections, and in particular is placed on a widening region of the mounting. Consequently, when placed on the widening region of the mounting, the clamping ring is able to expand in the circumferential direction and therefore also in the radial direction and thus hold the cover on the mounting. This facilitates installation of the cover on the mounting.

The widening region may in particular be the region of the mounting surrounded by the annular groove. The widening may be achieved, for example, by means of a conical or truncated conical outer contour of this region, in particular by means of such a configuration of the outer side wall of the annular groove.

The clamping ring may then in particular have segments which can be expanded elastically in the circumferential direction and which connect to one another segments holding the cover in the mounting, in particular pressing said cover against the mounting. The segments holding the cover in the mounting can be, for example, wedge-shaped segments and/or radially elastically deformable segments, in particular having radially acting spring elements.

A further development is that the bulb can be detached from the mounting, in particular if the clamping ring is arranged between the inner side of the cover and the mounting and can be deformed elastically in the radial direction, at least in some sections. The lighting device can in particular be configured such that, when the cover is pulled, the regions or elements that can be deformed elastically in the radial direction, in particular spring elements, give way with increasing force, and the cover can be taken off.

One refinement is that the clamping ring is produced from plastic. This permits a particularly lightweight and inexpensive clamping ring with high deformability (low modulus of elasticity).

The mounting may in particular be a heat sink, which permits a particularly simple structure. However, the mounting can also be an intermediate ring, which facilitates installation. In particular, the cover may be adhesively bonded to the intermediate ring in a process step independent of the rest of the lighting device. Long curing times and high curing temperatures of the adhesive may be implemented better as a result; logistic advantages during the production also result. The intermediate ring may in particular be fixed to a heat sink. The connection between the intermediate ring and the heat sink preferably permits a high flow of heat.

One possible development is additionally that the lighting device is a lamp. The lighting device may in particular be a semiconductor lighting device which has at least one semiconductor light source for light production. The light produced by the at least one semiconductor light source emerges through the cover. The cover may in particular cover the at least one semiconductor light source.

Preferably, the at least one semiconductor light source includes at least one light-emitting diode. If a plurality of light-emitting diodes is present, these may light up in the same color or in different colors. A color can be monochromatic (e.g. red, green, blue and so on) or multi-chromatic (e.g. white). In addition, the light emitted by the at least one light-emitting diode may be infrared light (IR-LED) or ultraviolet light (UV-LED). A plurality of light-emitting diodes may produce mixed light; e.g. white mixed light. The at least one light-emitting diode may contain at least one wavelength-converting luminescent material (conversion LED). The luminescent material may alternatively or additionally be arranged remotely from the light-emitting diode (“remote phosphor”). The at least one light-emitting diode may be present in the form of at least one individually housed light-emitting diode or in the form of at least one LED chip. A plurality of LED chips may be mounted on a common substrate (“submount”). The at least one light-emitting diode may be equipped with at least individual and/or common optical system for beam guidance, e.g. at least one Fresnel lens, collimator and so on. Instead of or in addition to inorganic light-emitting diodes, for example based on InGaN or AlInGaP, in general organic LEDs (OLEDs, e.g. polymer OLEDs) may also be used. Alternatively, the at least one semiconductor light source may have at least one diode laser, for example.

The lamp may in particular be a retrofit lamp, in particular an LED retrofit lamp, which is used to replace conventional lamps by a semiconductor lighting device, in particular an LED lamp. The LED retrofit lamp may in particular have an outer contour which approximates the outer contour of the lamp to be replaced and/or which has a similar emission of light.

Various embodiments further provide a method for installing a translucent cover of a semiconductor lighting device on a mounting of the semiconductor lighting device, wherein the method includes at least the following steps: (a) placing a clamping ring that may be deformed elastically in the circumferential direction thereof on a widening region of the mounting, the widening region of the mounting being surrounded by an annular groove; (b) inserting an undercut, in particular tapering, edge region of the cover into the annular groove of the mounting, the undercut edge region surrounding the clamping ring; and (c) sliding the clamping ring onto the widening region of the mounting until the clamping ring presses on the inner side of the cover.

As a result of sliding the clamping ring on, for example by means of firmly tightening screws, the wedge-shaped segments of the clamping ring slide downward on the widening region of the mounting, e.g. a conical annular surface of the mounting, e.g. a conical outer side wall of an annular groove, and widen the annular diameter until the segments rest on the undercut inner side of the cover.

The diameter of the clamping ring is now greater than the inner diameter of the cover, which means that the cover can no longer be taken off or only by means of a force that is higher than the inherent weight of the cover.

Various embodiments further provide a method for installing a translucent cover of a semiconductor lighting device having an undercut, in particular tapering, edge region on a mounting of the semiconductor lighting device, wherein the method includes at least the following steps: (a) inserting a clamping ring that may be deformed radially elastically, at least in some sections, into the cover; and (b) inserting the cover into an annular groove in the mounting. The clamping ring may then in particular be clipped into the glass bulb and after that latched onto the mounting. This permits particularly simple installation without special tools.

One refinement is that the clamping ring may be deformed elastically in the circumferential direction thereof, at least in some sections, and the step of inserting the cover into the annular groove includes at least sliding, in particular latching, the clamping ring onto a widening region of the mounting. This further facilitates installation. As it is slid on, in particular latched on, the diameter of the clamping ring is widened and the segments that may be deformed radially elastically (even in the fitted state of a clamping ring), in particular having spring elements, then rest on the inner side of the cover. The diameter of the radially elastically deformable segments is then greater than the internal diameter of the cover, which means that the cover can no longer be taken off or only by means of a force counter to the elastic deformation of the radially elastically deformable segments that is higher than the inherent weight of the cover.

These methods may in particular be carried out in addition to adhesive bonding of the cover to the mounting.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows, as a sectional illustration in oblique view, a detail from a lighting device according to a first embodiment;

FIG. 2 shows, as a sectional illustration in front view, a sketch in detail form of the lighting device according to the first exemplary embodiment;

FIG. 3 shows, as a sectional illustration in oblique view, a detail from a lighting device according to a second embodiment;

FIG. 4 shows, as a sectional illustration in front view, a sketch in detail form of the lighting device according to the second exemplary embodiment;

FIG. 5 shows, as a sectional illustration in oblique view, a detail from a lighting device according to a third embodiment;

FIG. 6 shows, as a sectional illustration in oblique view, a detail from a lighting device according to a fourth embodiment; and

FIG. 7 shows, as a sectional illustration in oblique view, a detail from a lighting device according to a fifth embodiment.

### DETAILED DESCRIPTION

The following detailed description refers to the accompanying drawings that show, by way of illustration, specific details and embodiments in which the disclosure may be practiced.

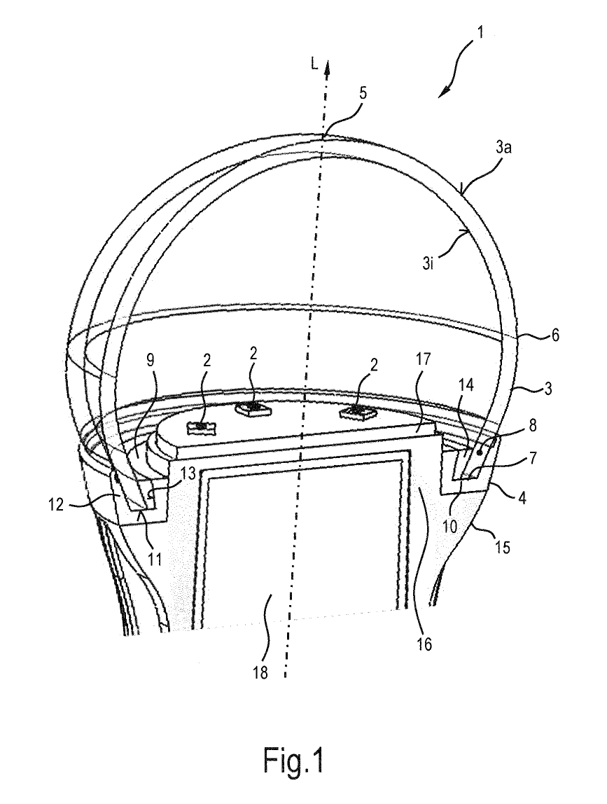

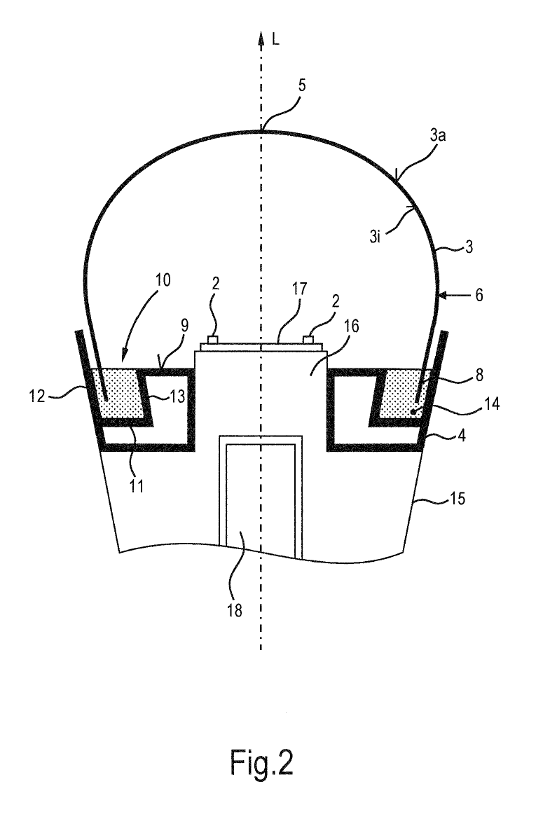

FIG. 1 shows, as a sectional illustration in oblique view, a detail from a lighting device 1 according to a first embodiment. FIG. 2 outlines the lighting device 1 in detail form as a sectional illustration in front view.

The lighting device 1 is provided as a semiconductor lighting device for use with at least one semiconductor light source, in particular light-emitting diode 2 (not shown). The lighting device 1 is further configured as an incandescent lamp retrofit lamp, in order to replace conventional incandescent lamps.

The lighting device 1 has a translucent (e.g. transparent or opaque) cover 3 and an annular mounting 4 for the cover 3.

The cover 3 consists of glass and has substantially the shape of a dome shaped like a spherical shell with an at least approximately equal wall thickness. The cover 3 is more than hemispherical and extends from the front tip 5 thereof beyond the mid-plane or equator 6 thereof and, at the rear or reverse end thereof, has an annular free edge 7. In its edge region 8 adjoining the free edge 7, the cover 3 may have a shape differing from the spherical shell shape, for example a conical or truncated cone shape (in particular with a wall section that is straight in profile). The cover 3 therefore has a shape tapering in the direction of the free edge 7 thereof and widening in the opposite direction along the longitudinal axis L. As a result, an undercut or an undercut shape is achieved on an inner side 3i of the edge region 8.

The cover 3 is further formed and arranged rotationally symmetrically with respect to a longitudinal axis L of the lighting device 1, the longitudinal axis L extending from back to front through the lighting device 1.

An upper side 9 of the mounting 4, pointing forward, has an annular groove 10 arranged concentrically around the longitudinal axis L, into which groove the cover 3 is inserted, at least with a part of the undercut edge region 8 thereof. The annular groove 10 has a horizontal base 11 and an outer side wall 12 extending in the longitudinal direction L (that is to say from back to front in the direction of the upper side 9 of the mounting 4) and serving as an outer side, and an inner side wall 13 widening in the longitudinal direction L and serving as an inner side.

The outer side wall 12 and the inner side wall 13 are therefore inclined in the same direction, here in the longitudinal direction L, from back to front at an increasing radial distance from the longitudinal axis L. The inner side wall 13 of the annular groove 10 thus has an undercut.

Here, the mounting 4 is designed as a separately produced intermediate ring, for example of plastic or metal, in particular aluminum. The mounting 4 is fitted by its rear side to a front side of a heat sink 15 over a large area via a thin adhesive layer. The heat sink 15 preferably consists of metal, in particular aluminum.

The mounting 4 is further arranged laterally around a cylindrical projection 16 of the heat sink 15 that projects forward from the front side of the heat sink 15, concentrically with respect to the longitudinal axis L, preferably without any gap or with only a little play. The projection 16 is used amongst other things as an installation and positioning aid for fixing the mounting 4. On a planar front side of the projection 16, the light-emitting diodes 2 are fitted over a common substrate 17 in the shape of a circular disk. The heat generated by the light-emitting diodes 2 is at least partly transferred via the substrate 17 to the heat sink 15 over a large area. The heat sink 15 further provides a driver cavity to receive a driver (not shown), which driver is able to supply the light-emitting diodes 2 with an electric operating signal (e.g. via electric connections, not shown).

The outer side wall 12 of the annular groove 10 and the outer side 3a of the cover 3 in the edge region 8 have a shape that is substantially identical or conformal at least in profile, so that a gap between them has a substantially constant thickness.

The cover 3 is fixed to the mounting 4 via a silicone adhesive as adhesive 14. To this end, first the adhesive 14 and after that the mounting 3 have been introduced into the annular groove 10. The edge region 8 of the cover 3 has been inserted into the adhesive 14 and is covered by the adhesive 14 on the inner side 3i thereof, on the outer side 3a thereof and on the free edge 7. In order to ensure the covering, the adhesive 14 has small glass spheres as filler, which serve as spacers.

The cover 3 with its outer side 3a is at only a slight distance from the outer side wall 12 of the annular groove 10, so that the two are spaced apart from each other by an only thin layer of adhesive 14. The cover 3 is therefore held in the annular groove 10 by means of the adhesive 14, at least on the outer side 3a of said cover. As a result, an effective transfer of heat between the cover 3 and the mounting 4 is made possible. This permits effective dissipation of heat which, for example, is transferred out of the space covered by the cover 3 (which space is heated by the light-emitting diodes 2) to the cover 3, to the mounting 4 and onward from the latter to the heat sink 15. For an improved dissipation of heat, the adhesive 14 can have a highly thermally conductive filler.

The volume between the inner side 3i of the edge region 8 of the cover 3 and the inner side of the annular groove 10 configured as an inner side wall 13, that is to say the volume between opposite undercut regions of the cover 3 and the annular groove 10, is filled with the adhesive 14, at least up to a specific height. As a result, after being cured the adhesive 14 acts as a form-fitting barrier which prevents the cover 3 falling out of the mounting 4 even when an adhesive action of the adhesive 14 has dwindled. In other words, the cover 3 is held in a form-fitting manner in the annular groove 10 by means of the adhesive 14, at least on the inner side 3i and 13.

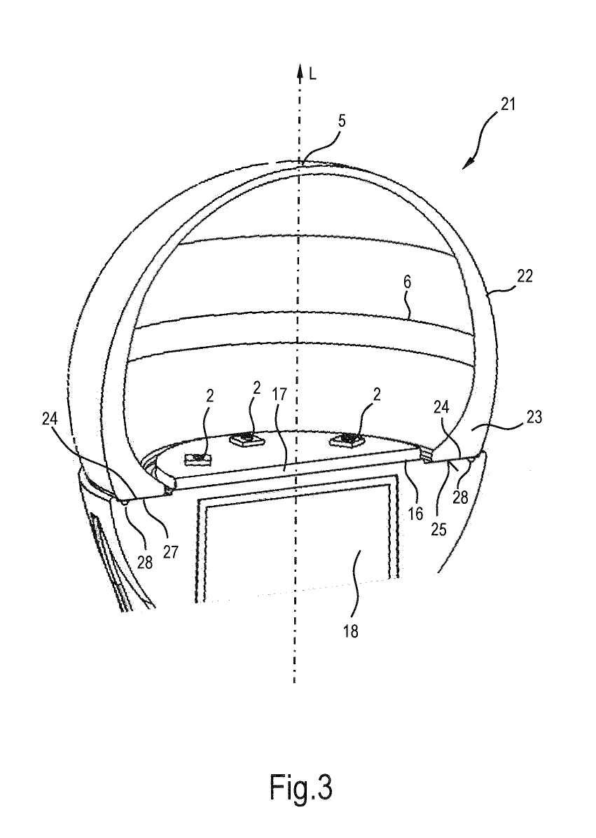

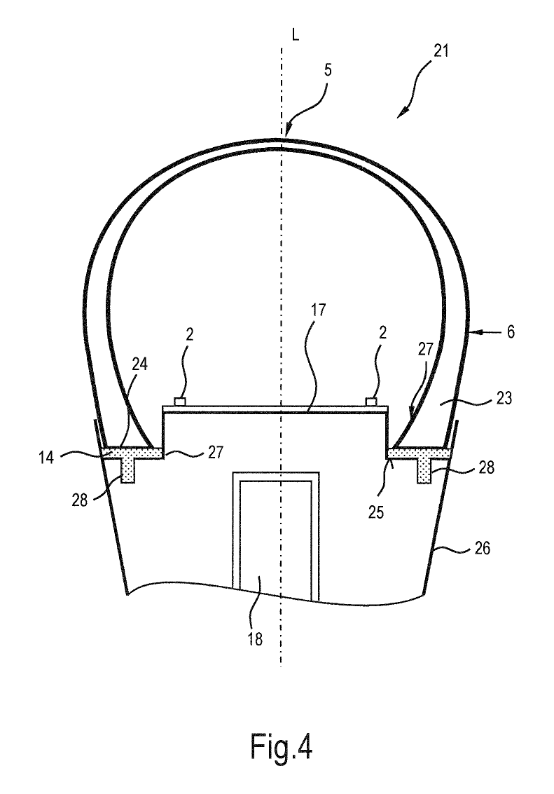

FIG. 3 shows, as a sectional illustration in oblique view, a detail from a lighting device 21 according to a second embodiment. FIG. 4 outlines the lighting device 21 in detail form as a sectional illustration in front view.

As opposed to the lighting device 1, the lighting device 21 includes a cover 22 having a widened edge region 23 and, at its free end 24, has a width (in the radial direction) of about three to five millimeters. The cover 22 is adhesively bonded with the free edge 24 of the widened edge region 23 to a substantially horizontal attachment surface 25 of the mounting 26. The attachment surface 25 here is formed as a base of a flat annular groove 27, the annular groove 27 delimiting the attachment surface 25 laterally. A transfer of heat from the cover 22 to the mounting 26 takes place substantially via a contact surface with the attachment surface 25, which is covered with adhesive 14.

As a result of the widened edge region (which has a thicker wall thickness then the rest of the cover) of the cover 22, a large contact surface with a correspondingly high heat transfer capability and a large adhesive surface is provided, while the rest of the cover 22 has a comparatively low wall thickness and therefore, overall, also a low weight. The adhesive connection has only a low overall height or thickness. Furthermore, the application of the adhesive 14 is also relatively simply possible, for example by being dispensed onto the attachment surface 25. A further advantage is the low thermo-mechanical stress which results in the case of this form of attachment. Despite the different thermal expansions of the cover 22 and of the mounting 26, no substantial stresses occur in the cover 22.

The attachment surface 25 here has an annual recess 28, trough or channel covered by the free edge 24 of the cover 22, which can receive excess adhesive 14.

The mounting 26 is now not an intermediate ring but the heat sink itself. The annular groove 27 does not have an undercut side wall for the form-fitting retention of the cover 22.

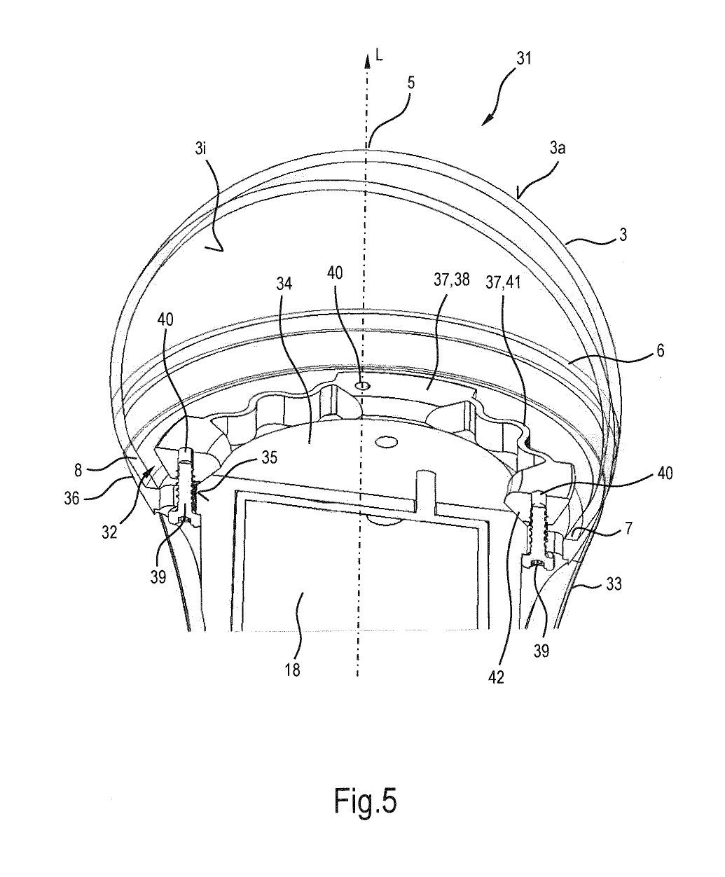

FIG. 5 shows, as a sectional illustration in oblique view, a lighting device 31 according to a third embodiment. The lighting device 31 has the cover 3 that tapers in an edge region 8 and is therefore undercut there. The cover 3 is inserted into an annular groove 32 in the front side of a mounting 33 formed as a heat sink (similar to the mounting 26), the annular groove 32 being deeper than the annular groove 27 of the mounting 26. The groove 32 surrounds laterally and delimits a projection 34 projecting forward (in the direction of the longitudinal axis L), the circumferential surface of which corresponds to an inner side or inner side wall 35 of the annular groove 32. The cover 3 is seated with the free edge 7 thereof on the base of the annular groove 32 and makes contact, with the outer side 3a of the edge region 8 thereof, with an outer side or outer side wall 36 of the annular groove 32.

The cover 3 is pressed against the mounting 33, more precisely the outer side wall 36 of the annular groove 32, by means of a clamping ring 37 placed on an inner side 3i of the edge region 8, and is thus held. In this way, the clamping ring 37 is able to achieve a particularly firm force-fitting and form-fitting connection or fixing of the cover 3 to the mounting 33. To this end, the clamping ring 37 is seated on the projection 34 and has a plurality of wedge-shaped regions or segments 38, four here, arranged rotationally symmetrically around the longitudinal axis L. The wedge-shaped segments 38 are configured as solid bodies or blocks which have an outline in the shape of a circular segment which, on the outer side thereof, are substantially conformal with the inner side 3i of the edge region 8 of the cover 3 and on the inner side thereof, are substantially conformal with the projection 34 of the mounting 33. In profile, the wedge-shaped segments 38 have a wedge shape.

The clamping ring 37 is fixed by means of a plurality of self-tapping screws 39. The screws 39 are led with their pin-like threaded region through the mounting 33 to a respective wedge-shaped segment 38. In each of the wedge-shaped segments 38, a hole 40 is provided to receive the screws 39, so that the wedge-shaped segments 38 can be drawn against the mounting 33 and onto the cover 3 by tightening the screws 39. By means of controlled tightening of the screws 39, the compressive force on the cover 3 can be adjusted.

The clamping ring 37 may furthermore be deformed elastically in its circumferential direction, at least in some sections, as a result of the fact that adjacent wedge-shaped segments 38 are connected by segments 41 that can be extended elastically in the circumferential direction. At the same time, the projection 34 is configured to be conical or in the form of a truncated cone, at least in the front region 42 thereof, such that it widens in the attachment direction of the clamping ring 37, i.e. counter to the longitudinal direction L or rearward. Consequently, as it is placed on the front, widening region 42, the clamping ring 37 expands in the circumferential direction and therefore also in the radial direction. In particular, in its unexpanded state the clamping ring 37 has a maximum diameter which is smaller than the inner diameter of the cover 3 at the free edge 7 thereof or the (attachment) opening of the cover 3. As the clamping ring 37 is placed on the widening region 42 of the projection 34, the maximum diameter of the clamping ring 37 is enlarged to such an extent that it is then larger than the inner diameter of the cover 3 at the free edge 7 of the latter. This facilitates installation of the cover 3 on the mounting 33.

For example, in order to install the cover 3, firstly the clamping ring 37 may be placed on the widening region 42, the clamping ring 37 not yet being expanded or expanded only slightly in the circumferential direction, so that the maximum diameter thereof is smaller than the inner diameter of the cover 3 at the free edge 7 of the latter. Consequently, the cover 3 can be inserted with the edge region 8 thereof into the annular groove 32 and, for this purpose, is led past the clamping ring 37. The edge region 8 of the cover 3 therefore surrounds the clamping ring 37 laterally. After that, by tightening the screws 39, the clamping ring is slid onto the region 42 widening in the direction of movement of the clamping ring 37 until the clamping ring 37 presses on the inner side 31 of the edge region 8 of the cover 3.

The cover 3 may additionally be fixed to the mounting 33 by means of an adhesive (not shown).

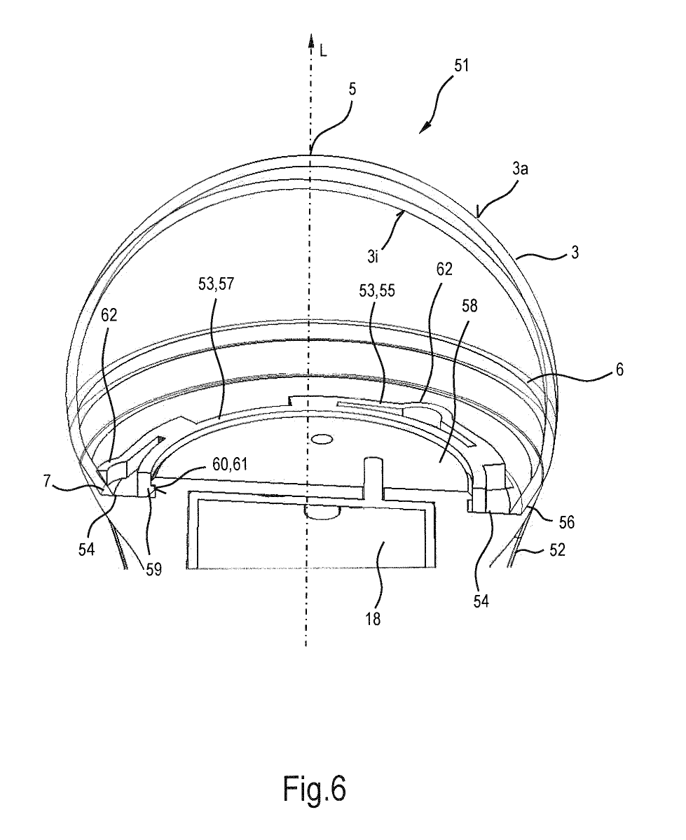

FIG. 6 shows, as a sectional illustration in oblique view, a detail of a lighting device 51 according to a fourth embodiment. The lighting device 51 has a clamping ring 53 for fixing the cover 3 to a mounting 52. Here, too, the cover 3 is inserted into a front-side annular groove 54 in the mounting 52 formed as a heat sink.

The clamping ring 53 is arranged between the inner side 3i of the cover 3 and the mounting 52, in a way similar to the clamping ring 37. However, the mounting 52 is now pressed against an outer side wall 56 of the annular groove 54 by sections or segments 55 of the clamping ring 53 that can be deformed in the radial direction, and is thus held in the mounting 52 in a form-fitting and possibly force-fitting manner counter to the inherent weight thereof, even in a position of the lighting device 51 that is oriented upside down. To this end, the segments 55 each have a spring element 62 located on the outside of the inner ring 57 and acting radially outward. The spring elements 62 are consequently likewise arranged rotationally symmetrically about the longitudinal axis L of the lighting device.

The spring elements 62 force the cover 3 from the inside against the outer side wall 56 of the annular groove 54 of the mounting 52.

The clamping ring 53 has an inner ring 57 that does not widen in the circumferential direction, which can be pulled over a projection 58 projecting forward and belonging to the mounting 52. The inner ring 57 has latching lugs 59 which engage in the projection 58. To this end, the projection 58 has an undercut 61 serving as a latching cutout on the circumferential surface thereof, which corresponds to an inner side wall 60 of the annular groove 54. The clamping ring 53 may thus be positioned and fixed on the projection 58.

In order to install the translucent cover 3, the procedure may be as follows: firstly, the clamping ring 53 is inserted into the cover 3. This is possible here, since the clamping ring 53 with spring elements 62 pressed in radially has an outer diameter which is smaller than the inner diameter of the cover 3 at the free edge 7 thereof.

As a result, the clamping ring 53 assumes a predetermined position on the inner side 3i of the cover. The inner side 3i of the cover 3 can be configured specifically for this purpose, for example have receptacles (not shown) to receive spring elements 62. The clamping ring 53 may, for example, be latched and/or clamped into the cover 3, in particular clipped in.

Then, the cover 3 equipped with the clamping ring 53 is inserted into the annular groove 54 in the mounting 52. The clamping ring 53 is drawn over the projection 58 and latched to the latter.

The cover 3 may be detached from the mounting 52 since, if a pull is applied to the cover 3 in the direction of the longitudinal axis L, the spring elements 62 give way or are forced inward and the cover 3 may be taken off.

The cover 3 can additionally be fixed to the mounting 52 by means of an adhesive (not shown).

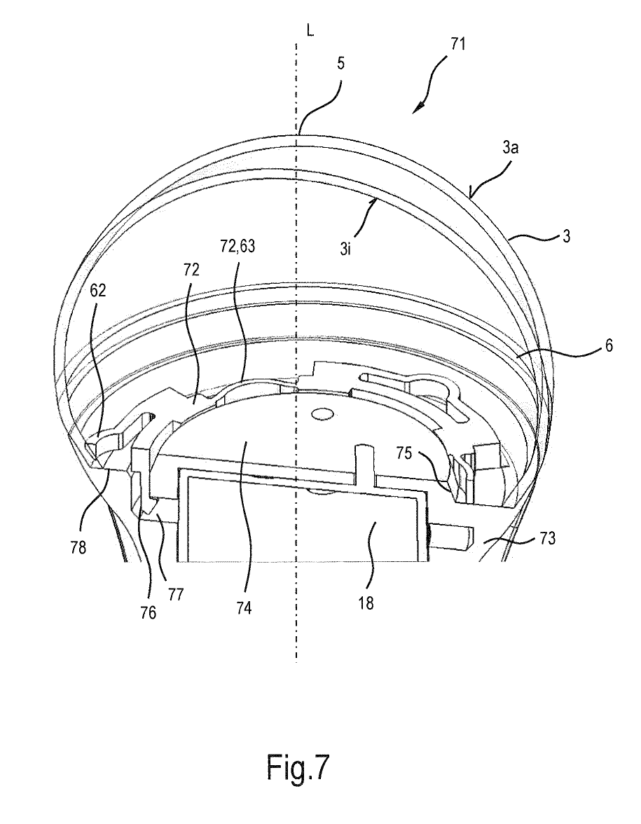

FIG. 7 shows, as a sectional illustration in oblique view, a detail from a lighting device 71 according to a fifth embodiment. The lighting device 71 is configured in a way similar to the lighting device 51.

The lighting device 71 has a clamping ring 72 which has spring elements 62 which are connected by segments 63 that can be expanded elastically in the circumferential direction. This facilitates installation of the mounting 73 configured as a heat sink, in particular in an annular groove 78 in the mounting 73, since the clamping ring 72 can be inserted into the cover 3 more simply than the clamping ring 53. At least part of the pressing force is only generated as the clamping ring 72 is placed on a front-side projection 74 which, in a way similar to the projection 34, has a region 75 widening in the attachment direction. As a result of being placed on the region 75, the clamping ring 72 is expanded in the circumferential direction and thus widened in the radial direction.

In order to be fixed to the mounting 73, the clamping ring 72 has latching hooks 76 fitted to the underside, which engage in matching latching cutouts 77 in the base of the annular groove 78.

The cover 3 may additionally be fixed to the mounting 73 by means of an adhesive (not shown).

While the disclosed embodiments has been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF DESIGNATIONS

1 Lighting device
2 Light-emitting diode
3 Cover
3a Outer side of the cover
3i Inner side of the cover
4 Mounting
5 Tip of the cover
6 Equator
7 Free edge of the cover
8 Edge region of the cover
9 Upper side
10 Annular groove
11 Horizontal base of the annular groove
12 Outer side wall of the annular groove
13 Inner side wall of the annular groove
14 Adhesive
15 Heat sink
16 Projection of the heat sink
17 Substrate
18 Driver cavity
21 Lighting device
22 Cover
23 Widened edge region of the cover
24 Free edge of the cover
25 Attachment surface of the mounting
26 Mounting
27 Annular groove
28 Recess
31 Lighting device
32 Annular groove
33 Mounting
34 Projection
35 Inner side wall of the annular groove
36 Outer side wall of the annular groove
37 Clamping ring
38 Wedge-shaped segment of the clamping ring
39 Screws
40 Hole in the wedge-shaped segment of the clamping ring
41 Segment of the clamping ring that can be expanded elastically in the circumferential direction
42 Widening region of the projection
51 Lighting device
52 Mounting
53 Clamping ring
54 Annular groove
55 Segments of the clamping ring that can be deformed in the radial direction
56 Outer side wall of the annular groove
57 Inner ring of the clamping ring
58 Projection
59 Latching lugs of the inner ring
60 Inner side wall of the annular groove
61 Undercut of the inner side wall
62 Spring element of the clamping ring
63 Segment of the clamping ring that can be expanded elastically in the circumferential direction
71 Lighting device
72 Clamping ring
93 Mounting
74 Projection
75 Widening region of the projection
76 Latching hook of the clamping ring
77 Latching cutouts of the mounting
78 Annular groove
L Longitudinal axis

1. A semiconductor lighting device, comprising a translucent cover and a mounting for the cover, wherein
the mounting has an annular groove,
the cover is inserted into the annular groove and
the cover is held in the annular groove, at least on a first side, by means of an adhesive.

2. The semiconductor lighting device as claimed in claim 1, wherein the cover is held in the annular groove, at least on a second side thereof, in a form-fitting manner by means of the adhesive.

3. The semiconductor lighting device as claimed in claim 2, wherein the second side is an inner side, the cover is inserted into the annular groove with an undercut edge region, and the annular groove has an undercut on the inner side thereof.

4. The semiconductor lighting device as claimed in claim 2, wherein the second side is an outer side, the cover is inserted into the annular groove with a widening edge region, and the annular groove has an undercut on the outer side thereof.

5. The semiconductor lighting device as claimed in claim 1, wherein the adhesive has spacers.

6. The semiconductor lighting device as claimed in claim 1, comprising a translucent cover and a mounting for the cover, wherein the cover has a widened edge region and is adhesively bonded with the widened edge region onto a substantially horizontal attachment surface of the mounting.

7. The semiconductor lighting device as claimed in claim 6, wherein the attachment surface of the mounting has at least one recess covered by the cover.

8. The semiconductor lighting device as claimed in claim 1, comprising a translucent cover that is undercut in an edge region, and a mounting for the cover, wherein the cover is pressed onto the mounting by means of a clamping ring attaching to an inner side of the edge region of said cover.

9. The semiconductor lighting device as claimed in claim 8, wherein the clamping ring is configured to be wedge-shaped, at least in some sections, and is arranged with the at least one wedge-shaped region thereof between the inner side of the cover and the mounting.

10. The semiconductor lighting device as claimed in claim 8, wherein the clamping ring is arranged between the inner side of the cover and the mounting and can be deformed elastically in the radial direction, at least in some sections.

11. The semiconductor lighting device as claimed in claim 9, wherein the clamping ring can be deformed elastically in the circumferential direction thereof, at least in some sections, and is placed on a widening region of the mounting.

12. The semiconductor lighting device as claimed in claim 1, wherein the mounting is a heat sink and an intermediate ring.

13. A method for installing a translucent cover of a semiconductor lighting device on a mounting of the semiconductor lighting device, the method at least comprising:
placing a clamping ring that can be deformed elastically in the circumferential direction thereof on a widening region of the mounting, the widening region of the mounting being surrounded by an annular groove;
inserting an undercut edge region of the cover into the annular groove of the mounting, the undercut edge region surrounding the clamping ring; and
sliding the clamping ring onto the widening region of the mounting until the clamping ring presses on the inner side of the cover.

14. A method for installing a translucent cover of a semiconductor lighting device having an undercut edge region on a mounting of the semiconductor lighting device, the method at least comprising:
inserting a clamping ring that can be deformed radially elastically, at least in some sections, into the cover; and
inserting the cover into an annular groove in the mounting.

15. The method as claimed in claim 14, where the clamping ring can be deformed elastically in the circumferential direction thereof, at least in some sections, and the step of inserting the cover into the annular groove comprises at least
sliding the clamping ring onto a widening region of the mounting.

16. The semiconductor lighting device as claimed in claim 6, wherein the attachment surface is substantially flat.

17. The semiconductor lighting device as claimed in claim 3, wherein the edge region is tapered.

18. The semiconductor lighting device as claimed in claim 8, wherein the edge region is tapered.

19. The method as claimed in claim 13, wherein the edge region is tapered.

20. The method as claimed in claim 14, wherein the edge region is tapered.
